(19) United States
(12) Patent Application Publication
(10) Pub. No.: US 2019/0204210 A1
(43) Pub. Date: Jul. 4, 2019

(54) Electrochemical Detection of Corrosion and Corrosion Rates of Metal in Molten Salts at High Temperatures

(71) Applicant: ARIZONA BOARD OF REGENTS ON BEHALF OF THE UNIVERSITY OF ARIZONA, Tucson, AZ (US)

(72) Inventors: Dominic Gervasio, Tucson, AZ (US); Hassan Elsentriecy, Tucson, AZ (US)

(21) Appl. No.: 16/330,739

(22) PCT Filed: Nov. 21, 2016
(86) PCT No.: PCT/US2016/063179

§ 371 Date: Mar. 5, 2019

Related U.S. Application Data
(60) Provisional application No. 62/384,028, filed on Sep. 6, 2016.

(51) Int. Cl. G01N 17/02; G01N 17/00

(52) U.S. Cl. CPC G01N 17/02; G01N 17/006

(57) ABSTRACT

The invention provides a method of electrochemically calculating the corrosion rate of a metal. The method includes electrically connecting a reference electrode to an electrometer, electrically connecting a working electrode formed of a sample metal to the electrometer, electrically connecting a counter electrode to the working electrode, submerging the reference electrode, the working electrode and the counter electrode in a molten salt at a temperature of at least 100° C. and as high as 900° C. and generating current by scanning a working electrode potential to generate a polarization curve from which the corrosion rate may be calculated.

### STATEMENT REGARDING FEDERALLY SPONSORED RESEARCH

This invention was made with government support under Grant No. DE-EE0005942, awarded by DOE. The government has certain rights in the invention.

### BACKGROUND OF THE INVENTION

Metal pipes used in various industrial applications can be susceptible to deterioration over time, such as due to corrosion when pipes are carrying electrolyte fluids. This requires that pipes be monitored to assess the rates of deterioration and to attend to scheduled maintenance for replacement of damaged pipes. The conventional gravimetric measurement for determining metal corrosion rates, inch is set forth in ASTM Standard D2688, can take weeks, months, or even years to yield an average corrosion rate. An average weight loss over time is acceptable when corrosion rates are steady, but if electrolyte flow and chemistry are changing over time, it is preferred to have a quick non-destructive method for repeatedly monitoring the changing corrosion rate and the changing conditions themselves.

One non-destructive method of measuring metal corrosion rates is an electrochemical method, which typically takes only a few minutes, so the effects of variations in chemists temperature, or flow of the material inside the pipe can be resolved virtually in real time. An electrochemical corrosion rate determination set forth in the Stern-Geary method, such as described in Ming-Kai Hsieh et al., “Bridging Gravimetric and Electrochemical Approaches to Determine the Corrosion Rate of Metals and Metal Alloys in Cooling Systems: Bench Scale,” Ind. Eng. Chm. Res. 2010, 49, 9117-9123 and incorporated herein by reference, takes minutes to perform and is non-destructive and therefore useful for monitoring the state of health of the pipe metal. This method allows one to assess when to do system component repairs or replacements ahead of failure. However, this method is limited because it cannot be used to detect corrosion or determine corrosion rates in high temperature environments. In fact, known methods are limited for use in environments of 100° C. or less. Thus, these methods have been unable to be used in connection with measuring corrosion and corrosion rates in molten salt environments, such as in power plants or in petroleum refining facilities.

For example, solar thermal power plants function in the following manner. Solar energy from the sun is used to heat a fluid to high temperatures. This fluid is then circulated through pipes to transfer its heat to a water source in order to produce steam. This steam is then converted into mechanical energy through the use of turbines, and this energy is then used to produce electricity. One example of a heat transfer fluid that is used in this system are molten salts. These fluids are capable of being heated to very high temperatures in order to effectively and efficiently heat the water source to produce steam. However, owing to the high temperatures, corrosion of the metal pipes carrying the heat transfer fluid is a concern, and the conventional methods of detecting corrosion or determining corrosion rates discussed above are unsuitable for these applications.

Accordingly, a method of electrochemically detecting corrosion or of determining corrosion rates of metals that can be utilized in high temperature environments, i.e., over 100° C., is desired.

### SUMMARY OF THE INVENTION

A method of electrochemically detecting corrosion or of measuring corrosion rates of metals in molten salt environments at temperatures of 100° C. or more is provided herein.

According to one aspect, the invention provides a method of electrochemically detecting corrosion in a metal, the method including the steps of electrically connecting a reference electrode to an electrometer, electrically connecting a sample metal to the electrometer, submerging the reference electrode and sample metal in a molten salt at a temperature of at least 100° C., and measuring the voltage of the reference electrode and comparing it to a predetermined voltage threshold to determine if corrosion of the sample metal is present. The reference electrode includes a tubular enclosure inert to high temperature, heat and chemicals having a proximal end and a distal end, wherein said distal end has an opening for ionic conduction between the reference electrode and a working electrode, a non-porous insulating ceramic rod sealingly connected to said opening at said distal end to form micro-cracks between said ceramic rod and said enclosure, an electrolyte disposed inside of said enclosure, said electrolyte comprising an alkaline metal salt, a sealing means for sealing said enclosure at said proximal end, and an electrical lead disposed in said electrolyte in said enclosure and extending through said sealing means at the proximal end of said enclosure.

The invention further provides a method of electrically connecting a reference electrode to an electrometer, electrically connecting a working electrode formed of a sample metal to the electrometer, electrically connecting a counter electrode to the working electrode, submerging the reference electrode, the working electrode and the counter electrode in a molten salt at a temperature of at least 100° C., and generating current by scanning a working electrode potential to generate a polarization curve from which the corrosion rate may be calculated.

The corrosion rate is linearly related to the corrosion current, which is the current for the metal oxidation reaction at the corrosion potential and is derived from the polarization curve when zero current flows between the working electrode and the counter or reference electrode. Measuring the voltage between the working and reference electrode when zero current flow between the working and counter or reference electrodes, determines the so called corrosion potential, E^{corr}, versus the reference electrode potential. Different values of the corrosion potential, E^{corr}, indicate different corrosive environments to the metal pipe.

The reference electrode includes a tubular enclosure inert to high temperature, heat and chemicals having a proximal end and a distal end, wherein said distal end has an opening for ionic conduction between the reference electrode and a working electrode, a non-porous insulating ceramic rod sealingly connected to said opening at said distal end to form micro-cracks between said ceramic rod and said enclosure, an electrolyte disposed inside of said enclosure, said electrolyte comprising an alkaline metal salt, a sealing means for sealing said enclosure at said proximal end, and an electrical lead disposed in said electrolyte in said enclosure and extending through said sealing means at the proximal end of said enclosure.

Another aspect of the invention provides an electrochemical sensor for measuring the corrosion rate of a metal which includes an electrochemical cell in a test loop having a reference electrode electrically connected to an electrometer, a working electrode formed of a sample metal electrically connected to the electrometer, a counter electrode electrically connected to the working electrode, and a potentiostat electrically connected to the electrometer, wherein the corrosion rate of the metal is measured in the presence of a flowing electrolyte. The reference electrode includes a tubular enclosure inert to high temperature, heat and chemicals having a proximal end and a distal end, wherein said distal end has an opening for ionic conduction between the reference electrode and a working electrode, a non-porous insulating ceramic rod sealingly connected to said opening at said distal end to form micro-cracks between said ceramic rod and said enclosure, an electrolyte disposed inside of said enclosure, said electrolyte comprising an alkaline metal salt, a sealing means for sealing said enclosure at said proximal end, and an electrical lead disposed in said electrolyte in said enclosure and extending through said sealing means at the proximal end of said enclosure.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic diagram illustrating the local cell corrosion mechanism;

FIG. 2 is a photograph of an electrochemical cell used to measure the rate of corrosion of steel in water, according to an embodiment of the invention;

FIG. 3 is a polarization curve generated from the electrochemical cell of FIG. 2;

FIG. 4(a) is a diagram of a system for measuring the Instantaneous Corrosion Rate (ICR) of a metal in a flowing electrolyte according to an embodiment of the invention;

FIG. 4(b) is an enlarged diagram of an electrochemical cell incorporated into the system of FIG. 4(a);

FIGS. 5(a)-(b) are photographs of a high-temperature alumina cracked junction reference electrode according to an embodiment of the invention;

FIG. 6 is a photograph of a copper/cuprous chloride electrode in a quartz housing according to an embodiment of the invention;

FIG. 7 is a diagram of an electrochemical system for measuring corrosion rates in an controlled atmosphere with controlled temperature, according to an embodiment of the invention;

FIG. 8 is a polarization curve illustrating an exemplary aerobic electrochemical test according to an embodiment of the invention;

FIG. 9 is a polarization curve illustrating an exemplary anaerobic electrochemical test according to an embodiment of the invention; and

FIG. 10 is a diagram illustrating a test loop for determining the corrosion rate of a metal sample in flowing molten salt at controlled temperature and atmosphere.

### DESCRIPTION OF THE INVENTION

The invention is directed to an electrochemical method of detecting corrosion of metals in the presence of molten salts at temperatures at or above 100° C. These methods utilize a reference electrode (RE) discussed more fully herein. The invention also provides a method of electrochemically determining corrosion rates of metals in the presence of molten salts at temperatures below, at or above 100° C. using the same RE. Systems incorporating the RE, for use in detecting corrosion or determining corrosion rates are also discussed.

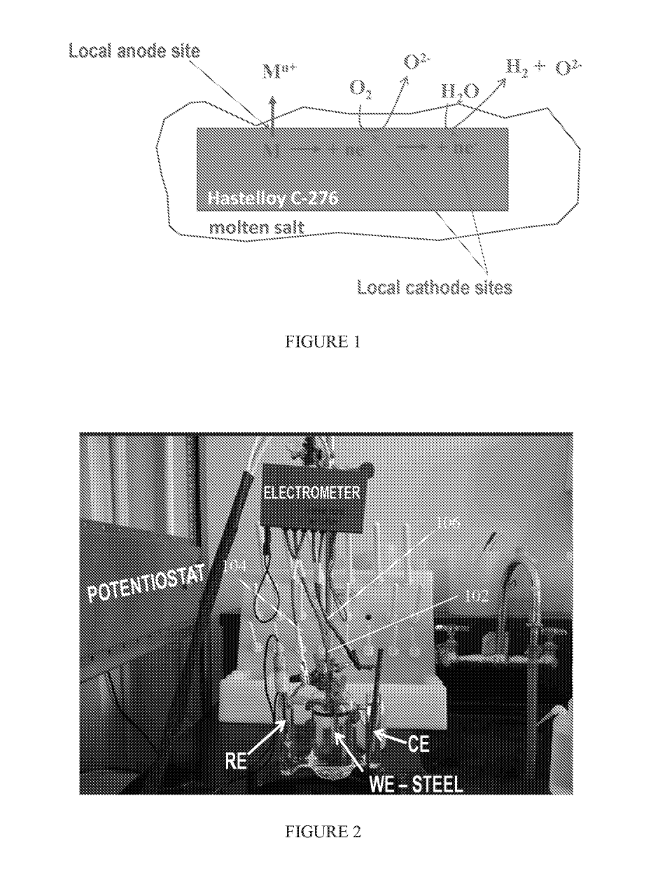

In molten salt environments, corrosion of a metal, such as a nickel alloy (Hastelloy® C-276) is illustrated in FIG. 1, which is a schematic diagram of the “local cell” cell corrosion mechanism. In this mechanism, metal oxidizes at a local anode on the metal surface, according to the following reaction (R1):

M→Mⁿ⁺+ne⁻

wherein M is a metal such as chrorium, nickel, iron, or any other suitable metal for this analysis.

Reaction R1 injects electrons into the bulk metal. The injected electrons are removed from the bulk metal by an oxidant, such as oxygen or water, at a local cathode on the metal surface, as shown in the following reaction (R2):

O₂+4e⁻→2 O²⁻ (where oxidant is molecular oxygen), or

H₂O+2^{e-}→H₂+O²⁻ (where oxidant is the protons in water)

When electrons flow in the metal, ions must flow in the liquid (e.g., molten salt) above the metal to balance the electrical charge. The ions flow completes the current loop. Charge balance reactions in the molten chloride salt, such as Na—K—Zn—Cl₄, are shown in the following reaction (R3):

Mⁿ⁺+nNaCl→Mⁿ⁺Cl⁻ₙ_{_}nNa⁺ and 2nNa⁺+nO²⁻→n Na⁺₂O²⁻

According to this local cell corrosion mechanism, if only reaction R1 occurs, no corrosion should be present, because structural materials would be held together by the electrostatic interaction between positive metal ions on the surface of the metal and negative electron charge inside of the metal. However, since the electrons are removed by the oxidants (e oxygen or water), the metal is no longer negatively charged, and instead becomes neutral in charge, so positive metal ions leave the metal and metal weight loss (i.e., corrosion) occurs. On the opposite surface of the pipe (i.e., the surface exposed to air), the pipe is protected from corrosion by having alloys with high chromium content applied to its outer surface. This minimizes corrosion because an electronically resistive chromium oxide layer forms on the surface, which prevents charge transfer of electrons from the metal to the oxidants, like oxygen or proton on water in air, and stops the local cell corrosion.

According to the methods discussed herein, the Instantaneous Corrosion Rate (ICR) for a represented metal can be accurately estimated either with a stagnant electrolyte (batch) or a flowing electrolyte. By monitoring the voltage between a metal and a reference electrode and the current and voltage properties of the metal, and by monitoring properties of the electrolyte material (i.e., molten salt), such as conductivity, dissolved oxygen concentration, dissolved water concentration, pressure, and flow rate of the electrolyte, a field test site with a real-time in line instrument for warning of corrosive environments and monitoring ICR can be created.

The electrochemical methods presented herein give the metal corrosion rate from analysis of a current versus potential curve (I/V curve), also called a polarization curve. For example, FIG. 2 illustrates a cell used to make electrochemical corrosion measurements relating to the corrosion of steel in water(batch) having a pH 7 at a temperature of 22° C., the cell having three (3) electrodes: (1) a corroding metal coupon or “working electrode” (WE, red lead) formed of steel, (2) a saturated calomel reference electrode (RE, white lead) to measure the potential of the WE, (E^{SCE}=+0.242V vs. standard hydrogen electrode, SHE), and (3) a graphite rod counter electrode (CE, blue lead) used to pass current with the corroding metal WE. The WE and RE are connected to the electrometer (a volt meter) which is connected to a potentiostat (a computerized controller). The zero current WE potential is called the corrosion potential, E_{corr}, and is reproducible for electrodes in a cell under the same conditions. The WE potential, E, is scanned slowly (0.1 mV sec⁻¹) to generate current, I.

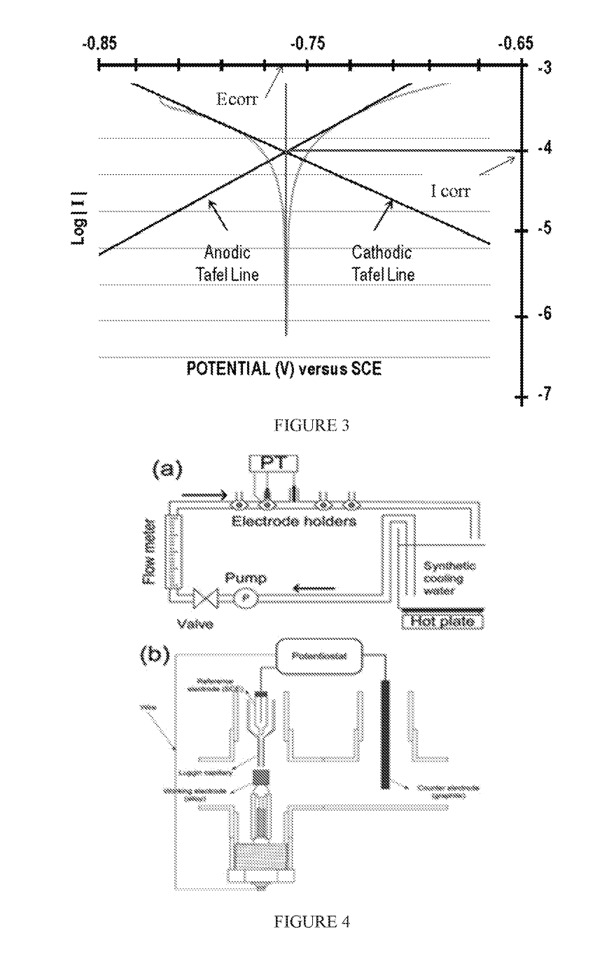

The resulting I/V data is illustrated in FIG. 3 and is analyzed by solving two simultaneous Butler-Volmer rate equations, as set forth in Electrochemistry, 2^{nd} Edition, ISBN 978-3-527-31069-2, C. Hamann, A. Hamnett, Wolf Vielstich, Wiley VCH (2007), p166 and incorporated herein by reference, for the two opposite but equal charge-transfer reactions occurring on the metal surface: (1) metal oxidation (e.g., iron to iron-oxide) coupled to (2) reduction of an oxidant (e.g., oxygen to water). ASTM Standard G102 (A380/A380M-13) and ASTM Standard G102-89 provides a specific procedure to determine metal corrosion rates from the IN data based upon the Stern-Geary method discussed above, which is a small signal version of the Butler-Volmer method. This method is non-destructive if the WE potential is sampled no more than 50 millivolts from the corrosion potential (in FIG. 3, E_{corr}=−0.77V vs SC The data set forth in FIG. 3 gave a polarization resistance (Rₚ=E_{corr}/I_{corr}) of 12 Ohm and instantaneous corrosion rate (ICR) of 79 micron per year.

Additionally, the effects of oxygen and water concentrations and flow rate of the electrolyte on the metal corrosion rate can be measured in a flow cell as well, as illustrated in FIGS. 4(a) and 4(b). FIG. 4(a) illustrates the system for measuring the ICR of a metal in a flowing electrolyte. FIG. 4(b) is an enlarged diagram of the electrochemical cell incorporated into the system. The flow rate, temperature and pressure of the electrolyte will be evaluated to determine the metal corrosion rate in the test loop and field. The electronics can be an electronic load or a source from a source meter to make an IN curve, like FIG. 3, from which one can derive the corrosion rate from the corrosion current according to ASTM methods (ASTM G 102-89). The electronic load can be computer controlled to give IN curves for the metal in the electrolyte in time, so the corrosion rate can be measured at different times.

To this point, all corrosion rate determination is applicable to any metal in an electrolyte system, as long as those systems are at temperatures of about 100° C. or less for aqueous systems and when temperatures are up to and above 100° C. for molten salt systems. Laboratory testing has revealed that the cause of corrosion of metal pipe on the salt side (inside) of a pipe filled with molten salt (at temperatures well above 100° C.) is due to dissolved oxidants, as described in K. Vignarooban et al., “Stability of Hastelloys in Molten Metal-Chloride Heat-transfer Fluids for Concentrated Solar Power Applications”, Solar Energy, 103, pp. 62-69 (2014) and incorporated herein by reference. To prevent pipe breaks due to corrosion of metal on the inside of the pipe, the invention provides a corrosion detection method and system which warns of the presence and effects of dissolved oxidants in the molten salt and can operate at the relatively high temperatures of the molten salt.

In one embodiment of the invention, a method of electrochemically detecting corrosion or of calculating the corrosion rate of a metal is provided. This method is advantageous because it can be utilized in molten salt environments at temperatures of 100° C. or higher, even as high as 900° C. As set forth above, this method may be used, for example, to detect corrosion already present in pipes carrying heat transfer fluids, e.g., molten salts, used in solar-thermal power plants or oil refineries. Detecting corrosion already present in the pipes is important to be able to understand the “state of health” of the system, so as to avoid any potential deterioration of the pipes. This method may also be used to determine corrosion rates of the pipes to be able to monitor the state of health of the system.

The methods set forth herein utilize a reference electrode (RE), which is in an ionic conducting solution, called a half-cell, with a constant electrode potential. In one embodiment, the RE is used in order to measure the potential of a metal sample in molten salt at high temperatures (up to 900° C. or more). A metal in contact with its cationic salt has constant potential and is the basis for making the RE. The RE used in molten salt was developed to simulate the traditional silver/silver chloride (Ag/AgCl) reference electrode (SSE) used in aqueous solutions. A reference electrode such as those disclosed in co-pending U.S. Provisional App. No. 62/258,853 and incorporated herein by reference may be used in the methods disclosed herein,

In one embodiment, a stable and robust RE may be made from a metal wire (like silver wire, Ag-wire) in contact with its ionic metal salt (like silver chloride, Ag⁺Cl⁻) and an alkaline metal salt (like potassium chloride, KCl) inside a quartz tube with an insulating ceramic rod (like alumina or zirconia rod) sealed at the bottom, such as by melting it into one end of the quartz tube, so that micro-cracks form between the ceramic rod and quartz (called a cracked junction, CJ). The CJ gives a very tortuous path for ion conduction from inside the quartz tube to outside the tube. The main improvement in this reference electrode is that a zirconia rod was melted into one end of heavy-walled quartz tubing was used to form the cracked junction. This is much more stable than thin walled quartz and alumina.

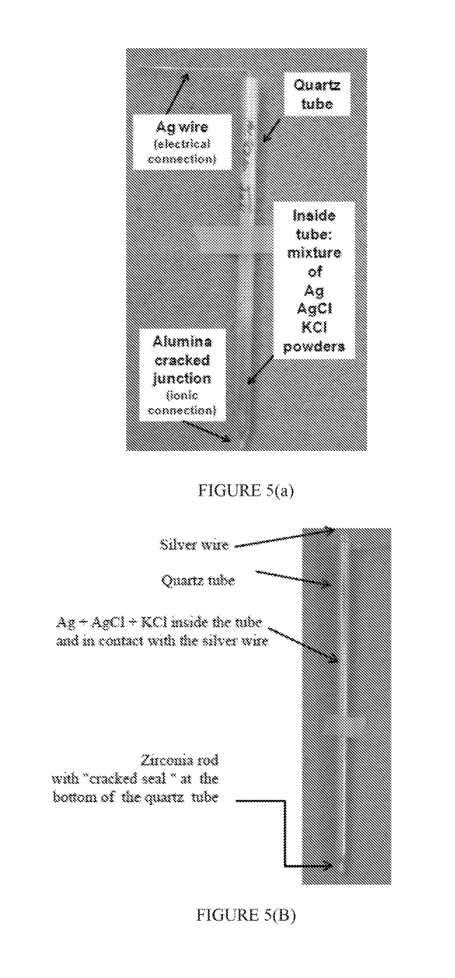

In one embodiment, the housing is made of quartz so that the reference electrode could be used at temperatures up to 900° C. The quartz tube was terminated with a “cracked junction” (CJ) for ionic connection between the reference electrode and the working electrode (test alloy) of the electrochemical cell. This quartz tube was filled with proper amounts of 1 part Ag metal powder, 1 part AgCl powder and 1 part KCl powder which were mixed well by grinding and then poured into the quartz tube. A silver wire was inserted almost completely down the tube for electrical connection as shown in FIGS. 5(a)-(b). The CJ was made by fusing the quartz tube over an alumina rod so that the rod was firmly held in place as if sealed into the quartz. However, due to differences in expansion coefficients of the alumina and quartz, micro cracks form at the quartz and alumina interface resulting in a very tortuous path for ion diffusion between the inside of the quartz tube containing the reference electrode and the outside which gives ionic contact to the electrochemical cell. This reference electrode is referred to as the Alumina CJ.

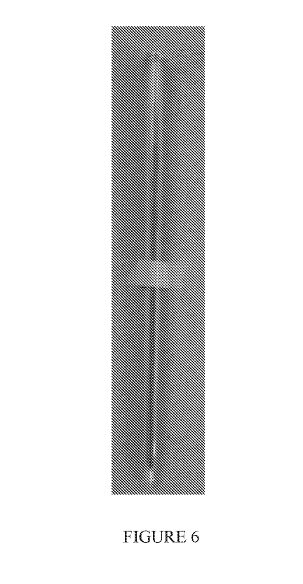

In another embodiment, a combination of metal and metal-cationic salt was used to make another RE, a copper/cuprous chloride reference electrode (CCE) as illustrated in FIG. 6. In the CCE, a copper wire is inserted into a mixture of chemicals (Cu+CuCl+KCl) housed in a quartz tube terminating with a sealed ceramic rod (Zirconia) at the bottom of the tube. The zirconia sealed in quartz has a tortuous crack for ionic exchange between the reference chamber and main chamber of salt holding the electrode under test. This ion exchange is needed in order to complete the electrical connection between the reference electrode (RE) and the working electrode (WE) under test in the molten salt, so the potential of the working electrode under test can be measured and controlled during the electrochemical polarization measurements of the WE under test.

The RE is advantageous because it and its electrical potential remains stable in molten salt at temperatures above 100° C., including up to 900° C. or higher.

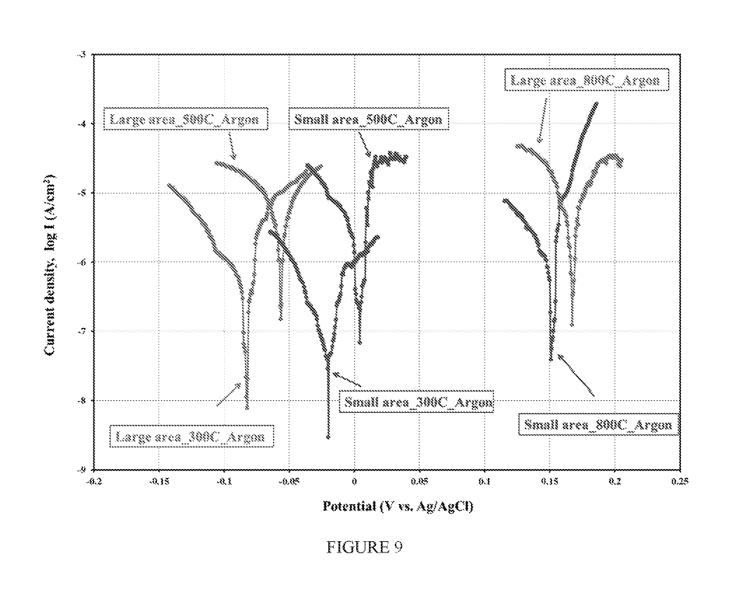

In one embodiment of the method, an RE is connected to an electrometer a voltmeter) in the molten salt environment inside of the pipe to be tested. The negative lead of the voltmeter is connected to the RE, while the positive lead of the voltmeter is connected to a piece of sample metal. The sample metal should be the same metal from which the pipes are formed. The entire cell is then placed in the molten salt inside of the pipe. The voltage of the sample metal versus the RE in this environment is then measured. If the voltage is at or above a predefined threshold based upon the type of metal in molten salt with air, as given in Table 1 and FIG. 8, this signifies that air has leaked into the molten salt inside of the pipe due to corrosion. If the voltage is below the predefined threshold, based upon the type of metal in anaerobic molten salt as given in Table 2 and FIG. 9, then the state of health of the system is acceptable and no corrosion is present.

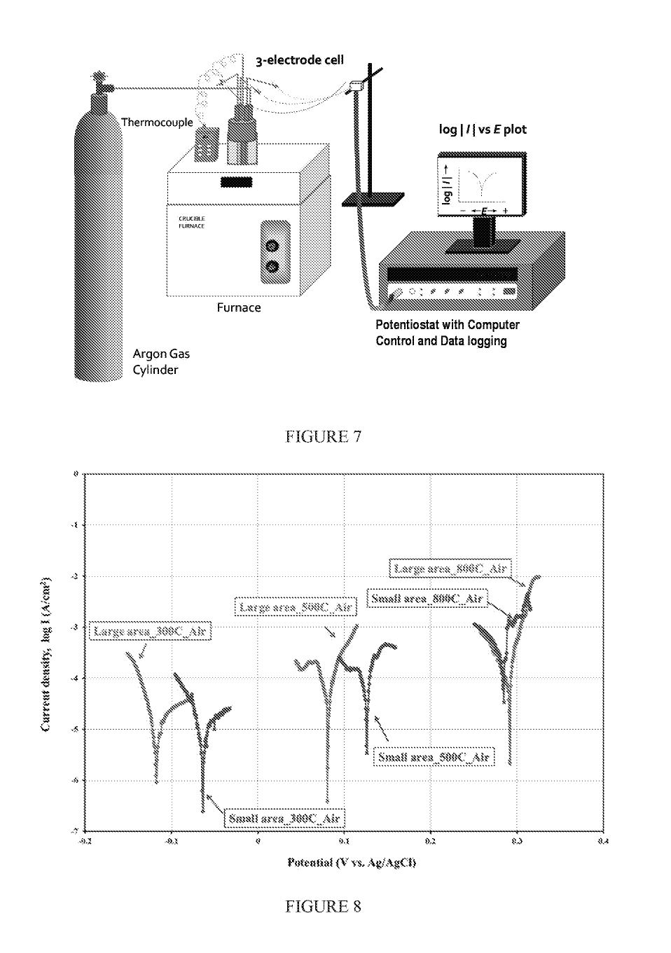

In another embodiment, the Instantaneous Corrosion Rate (ICR) of a metal in a molten salt environment may be determined. In this method, referring back to FIG. 2, the cell includes three (3) electrodes: (1) the metal to be tested, or the working electrode (WE, red lead 102), (2) a reference electrode (RE, white lead 104), such as those described herein to measure the potential of the WE, and (3) a counter electrode (CE, blue lead 106) to pass current from the WE, wherein the counter electrode is formed of the same metal as the working electrode. The entire cell is placed in a molten salt, which is maintained at a temperature from 300° C. to about 800-900° C. in a crucible furnace. The WE and RE are connected to the electrometer (e.g., a voltmeter) which is connected to a potentiostat (a computerized controller). The connections between the three-electrode cell, which is submerged in a molten salt in a crucible furnace, the electrometer, and the potentiostat is illustrated in FIG. 7. An argon gas cylinder may also be in communication with the molten salt sample, as described more fully in Example 2 below.

### Example 1

Aerobic electrochemical tests. To perform the corrosion rate determination, the metal to be tested (the WE) is provided as a metal coupon. The metal was tested in molten salt previously sparged with compressed air and results are given in FIG. 8 and Table 1. In this example, the metal coupon was formed of a nickel-molbydenum-chromium alloy, Hastelloy® C-276 commercially available from Mega Mex of Humble, Tex. The metal coupon is wet polished with 600 grit silicon carbide (SiC) paper, rinsed with deionized water, and then rinsed with acetone. The metal coupon (WE) and CE and RE are then immersed in molten salt. The molten salt previously sparged with air at 175 SCCM at 500° C. for one hour. About 150 g of molten salt (NaCl—KCl—ZnCl₂) was held at 300° C. for about 30 minutes, and then the metal coupon was submerged into the molten salt already containing the CE and RE at this temperature. After reaching a stable open circuit voltage (OCP) (about five minutes after sample insertion), the potential of the metal sample was then scanned from −30 mV vs. open circuit potential (OCP) to +30 mV vs. OCP at a scan rate of 0.2 mV/s. After this measurement was taken, the temperature of the molten salt was raised to about 500° C. and the potential was scanned again. The same procedure was then performed at about 800° C. Two different sizes of samples in the same mass of salt (150 g) were used to investigate the effect of sample size on the corrosion rate.

In order to estimate the ICR, the corrosion current i_{corr} at the corrosion potential E_{corr} is determined from I/V data and the ICR is determined using the formula derived from Faraday's law, which is given by ASTM Standards G59 and G102:

$$CR ( μm / y ) = {k}_{1} [ \frac{icorrEW}{ρ} ]$$

where k₁=3.27 in μm g μA⁻¹ cm⁻¹ yr⁻¹, i_{corr}=corrosion current density in μA cm⁻² (determined from the I/V curve), EW=equivalent weight of the metal being tested (i.e., 27.01 g/eq for the Hastelloy® alloy), ρ=density of the metal being testing (i.e., 8.89 g cm⁻³ of the Hastelloy® alloy).

As shown in FIG. 8, which illustrates the polarization curves of the Hastelloy® C-276 samples in 150 gm of molten NaCl—KCl—ZnCl₂ salt at different temperatures in air, the polarization currents increase with an increase in temperature for Hastelloy® C-276 corrosion in Zn ternary (mp 204C) molten salt in air. In addition, there is a clear positive shift in the OCP with increase in temperature due to higher oxygen concentration on the metal surface, which is due to better transport of oxygen from air because of lower viscosity of the molten salt and higher permeability of oxygen in the molten salt. The corrosion parameters obtained from the polarization curves of FIG. 8 are presented in Table 1 below.

TABLE 1
Corrosion parameters obtained from polarization curves in FIG. 8

| | | Corrosion | Corrosion current | |
|---|---|---|---|---|
| Temperature (° C.)/ | Surface area | potential, E_{corr} | density, I_{corr} | Corrosion rate |
| Atmosphere | for WE and CE | (V) | (μA/cm²) | (μm/y) |
| 300 | WE = 5.6 cm² | −0.065 | 3.98 | 39.52 |
| (Small), Air | CE = 10.5 cm² | | | |
| 300 | WE = 17.5 cm² | −0.115 | 5 | 49.65 |
| (Large), Air | CE = 27.3 cm² | | | |
| 500 | WE = 5.6 cm² | 0.125 | 39.8 | 395.21 |
| (Small), Air | CE = 10.5 cm² | | | |
| 500 | WE = 17.5 cm² | 0.08 | 43.6 | 432.94 |
| (Large), Air | CE = 27.3 cm² | | | |
| 800 | WE = 5.6 cm² | 0.284 | 251 | 2492.43 |
| (Small), Air | CE = 10.5 cm² | | | |
| 800 | WE = 17.5 cm² | 0.291 | 239.88 | 2382 |
| (Large), Air | CE = 27.3 cm² | | | |

As shown in the Table 1, the corrosion rates of the small sized sample are very similar to those of the large sized sample, which suggests that there is no strong dependency of corrosion rate on the metal coupon size for this range of coupons sizes (˜5 to 18 cm²) when holding the mass of the molten salt constant at about 150 g. Also, the corrosion potential is quite high as the corrosion potential is the weight average of the metal oxidation potential and the very high and positive oxygen reduction potential, which is 1.23 V vs NHE. The corrosion potential of 0.296 V vs SSE for the metal in molten salt at 800° C. is a warning of oxygen in the salt. The corrosion rate is very high at high temperatures. The high corrosion rate can be used to predict pipe failure time if air is in the salt.

### Example 2

Anaerobic electrochemical tests. For anaerobic electrochemical corrosion testing, the salt (NaCl—KCl—ZnCl₂) was heated to melt at about 500° C., and then argon gas (see FIG. 5) was flowed into the salt at 175 SCCM for about 30 minutes. The molten salt was brought to 300 C and the SSE RE and then the WE and CE (Hastelloy® C-276 alloy) were inserted. When the CE and WE samples were inserted, the gas bubbling into the molten salt was stopped, and instead gas was flowed above the salt. After the OCP became stable (about five minutes after sample insertion), the I-V curve was measured. After the first I/V curve was acquired at 300° C., the argon gas again flowed into the salt until the temperature reached 500° C. The argon flow was then switched against to over the salt. After the OCP was stable, the UV curve was measured again at 500° C. The sample procedure was used to obtain the I/V curve at about 800° C. The metal samples remained in the molten salt since they were initially inserted at 300° C. until tests were finished at 800° C.

As shown FIG. 9, the corrosion currents significantly decreased under anaerobic conditions. Moreover, these polarization currents measured under anaerobic conditions slightly increased and the OCP shifted to more positive values as the salt temperature increased. It is practically impossible to completely remove all oxygen from the salt, so the positive shift in OCP is probably due the higher permeability of residual oxygen in the salt as the viscosity of the salt decreased with increasing temperature. Although there is positive shift in OCP values with increasing temperature under anaerobic conditions, all other things being equal, the OCP values measured under anaerobic conditions were still seen to be about 100 mV more negative than those OCP values measured under aerobic condition. Particularly noticeable is the difference in OCPs for metal in aerobic and anaerobic molten salt at 800° C. The corrosion rates obtained from the polarization curves of FIG. 9 are presented in Table 2 below.

TABLE 2
Corrosion parameters obtained from polarization curves in FIG. 9

| | | Corrosion | Corrosion current | |
|---|---|---|---|---|
| Temperature (° C.)/ | Surface area | potential, E_{corr} | density, I_{corr} | Corrosion rate |
| Atmosphere | for WE and CE | (V) | (μA/cm²) | (μm/y) |
| 300 | WE = 3.5 cm² | −0.02 | 0.501 | 4.97 |
| (Small), Argon | CE = 8.4 cm² | | | |
| 300 | WE = 14 cm² | −0.08 | 0.795 | 7.89 |
| (Large), Argon | CE = 24.5 cm² | | | |
| 500 | WE = 3.5 cm² | 0.004 | 1.58 | 15.68 |
| (Small), Argon | CE = 8.4 cm² | | | |
| 500 | WE = 14 cm² | −0.057 | 1.86 | 18.46 |
| (Large), Argon | CE = 24.5 cm² | | | |
| 800 | WE = 3.5 cm² | 0.15 | 3.98 | 39.52 |
| (Small), Argon | CE = 8.4 cm² | | | |
| 800 | WE = 14 cm² | 0.166 | 3.16 | 31.37 |
| (Large), Argon | CE = 24.5 cm² | | | |

As shown in Table 2, the corrosion rates under anaerobic condition at 800° C. are about 50 times lower than the corrosion rates measured under aerobic conditions (Table 1), all other things being equal. It is also noted that corrosion rates of the small-sized sample are again very similar to those of the large-sized samples in anaerobic molten salt, which suggests that in these short term tests there is no dependency of corrosion rate on the metal size immersed in same salt mass (150 gm) as previously found on testing under aerobic conditions (Table 1).

The electrochemical methods set forth in both Examples 1 and 2 above are in good agreement with the corrosion rates calculated for the same system by the conventional gravimetric methods set forth herein.

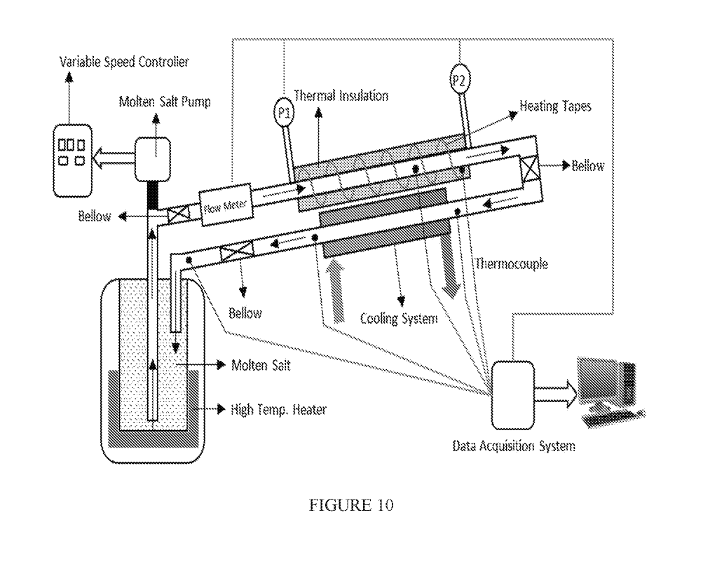

In another embodiment of the invention, an electrochemical sensor system, such as the system illustrated in FIGS. 4(a)-(b), is provided. The electrochemical sensor can be used for measuring the OCP and ICR of a metal in flowing molten salt. The electrochemical sensor utilizes an electrochemical cell made using ceramic feed-throughs into the metal pipe with molten salt in order to detect the state of health of the system and the pipe, as illustrated in FIG. 10. Here, a test loop is illustrated showing the pipe into feed-throughs can be inserted in order to detect the oxygen content of salt and the corrosion rate of metal in the salt. This oxygen content measurement is done using the OCP of a metal coupon versus an RE and the corrosion rate of the pipe is measured using polarization measurements (UV tests) of a metal coupon in the molten salt.

1. A method of electrochemically detecting corrosion in a metal, the method comprising the steps of:
a) electrically connecting a reference electrode to an electrometer, the reference electrode including:
a tubular enclosure inert to high temperature, heat and chemicals having a proximal end and a distal end, wherein said distal end comprises an opening for ionic conduction between the reference electrode and a working electrode,
a non-porous insulating ceramic rod sealingly connected to said opening at said distal end to form micro-cracks between said ceramic rod and said enclosure,
an electrolyte disposed inside of said enclosure, said electrolyte comprising an alkaline metal salt,
a sealing means for sealing said enclosure at said proximal end, and
an electrical lead disposed in said electrolyte in said enclosure and extending through said sealing means at the proximal end of said enclosure;
b) electrically connecting a sample metal to the electrometer;
c) submerging the reference electrode and sample metal in a molten salt at a temperature of at least 100° C.; and
d) measuring the voltage of the reference electrode and comparing it to a predetermined voltage threshold to determine if corrosion of the sample metal is present.

2. The method of claim 1, wherein the temperature of the molten salt is as high as 900° C.

3. A method of electrochemically calculating the corrosion rate of a metal, the method comprising the steps of:
a) electrically connecting a reference electrode to an electrometer, the reference electrode including:
a tubular enclosure inert to high temperature, heat and chemicals having a proximal end and a distal end, wherein said distal end comprises an opening for ionic conduction between the reference electrode and a working electrode,
a non-porous insulating ceramic rod sealingly connected to said opening at said distal end to form micro-cracks between said ceramic rod and said enclosure,
an electrolyte disposed inside of said enclosure, said electrolyte comprising an alkaline metal salt,
a sealing means for sealing said enclosure at said proximal end, and
an electrical lead disposed in said electrolyte in said enclosure and extending through said sealing means at the proximal end of said enclosure;
b) electrically connecting a working electrode formed of a sample metal to the electrometer;
c) electrically connecting a counter electrode to the working electrode;
d) submerging the reference electrode, the working electrode and the counter electrode in a molten salt at a temperature of at least 100° C.; and
e) generating current by scanning a working electrode potential to generate a polarization curve from which the corrosion rate may be calculated.

4. The method of claim 4, wherein the temperature of the molten salt is as high as 900° C.

5. The method of claim 4, wherein the corrosion rate may be calculated based upon a stagnant molten salt environment or a flowing molten salt environment.

6. The method of claim 4, wherein the electrometer is connected to a potentiostat.

7. The method of claim 4, wherein the corrosion rate is calculated based upon formula:
$$CR ( μm / y ) = {k}_{1} [ \frac{icorrEW}{ρ} ]$$
wherein k₁ is 3.27 in μm g μA⁻¹ cm⁻¹ yr⁻¹, i_{corr} is the corrosion current density, EW is the equivalent weight of the sample metal, and ρ is the density of the sample metal.

8. The method of claim 4, further comprising the step of flowing argon gas into the molten salt before step (h).

9. The method of claim 4, wherein the working electrode potential is scanned at no more than 50 millivolts from a corrosion potential.

10. An electrochemical sensor for measuring the corrosion rate of a metal, comprising an electrochemical cell in a test loop which includes:
a reference electrode electrically connected to an electrometer, the reference electrode including:
a) a tubular enclosure inert to high temperature, heat and chemicals having a proximal end and a distal end, wherein said distal end comprises an opening for ionic conduction between the reference electrode and a working electrode,
b) a non-porous insulating ceramic rod sealingly connected to said opening at said distal end to form micro-cracks between said ceramic rod and said enclosure,
c) an electrolyte disposed inside of said enclosure, said electrolyte comprising an alkaline metal salt,
d) a sealing means for sealing said enclosure at said proximal end, and
e) an electrical lead disposed in said electrolyte in said enclosure and extending through said sealing means at the proximal end of said enclosure;
a working electrode formed of a sample metal electrically connected to the electrometer;
a counter electrode electrically connected to the working electrode; and
a potentiostat electrically connected to the electrometer,
wherein the corrosion rate of the metal is measured in the presence of a flowing electrolyte.

11. The electrochemical sensor of claim 10, wherein the ceramic rod comprises alumina or zirconia.

12. The electrochemical sensor of claim 10, wherein the alkaline metal salt is potassium chloride.

13. The electrochemical sensor of claim 10, wherein the electrical lead is a copper wire.

14. The electrochemical sensor of claim 10, wherein the electrical lead is a silver wire.

15. The electrochemical sensor of claim 10, wherein the tubular enclosure is made of quartz.

16. The electrochemical sensor of claim 10, wherein the flowing electrolyte is a molten salt.

17. The electrochemical sensor of claim 16, wherein the molten salt is a NaCl—KCl —ZnCl₂ salt.

18. The electrochemical sensor of claim 10, wherein the sample metal is a metal alloy.

19. The electrochemical sensor of claim 18, wherein the metal alloy is a nickel-molybdenum-chromium alloy.

20. The electrochemical sensor of claim 10, wherein the sample metal is a portion of a metal pipe.
